(19) United States
(12) Patent Application Publication
(10) Pub. No.: US 2015/0012696 A1
(43) Pub. Date: Jan. 8, 2015

(54) DATA MANAGEMENT DEVICE, DATA MANAGEMENT SYSTEM, AND DATA MANAGEMENT METHOD

(71) Applicant: FUJITSU LIMITED, Kawasaki-shi (JP)

(72) Inventor: Yusuke INAI, Kawasaki (JP)

(73) Assignee: FUJITSU LIMITED, Kawasaki-shi (JP)

(21) Appl. No.: 14/284,629

(22) Filed: May 22, 2014

(30) Foreign Application Priority Data
Jul. 5, 2013 (JP) 2013-141254

(51) Int. Cl. G06F 3/06

(52) U.S. Cl. CPC G06F 3/0686; G06F 3/0611; G06F 3/0655
USPC 711/111

(57) ABSTRACT

A data management device includes a processor. The processor is configured to transmit data of a logical volume to a library device different from the data management device so as to record the data of the logical volume on a portable recording medium managed by the library device. The processor is configured to prepare recognition information whenever data of a logical volume is recorded on the portable recording medium. The recognition information is used to recognize entire first logical volumes. Data of the first logical volumes is recorded on the portable recording medium. The processor is configured to transmit the recognition information to the library device so as to record the recognition information on the portable recording medium.

### CROSS-REFERENCE TO RELATED APPLICATION

This application is based upon and claims the benefit of priority of the prior Japanese Patent Application No. 2013-141254 filed on Jul. 5, 2013, the entire contents of which are incorporated herein by reference.

### FIELD

The embodiments discussed herein are related to a data management device, a data management system, and a data management method.

### BACKGROUND

A tape library system that uses a tape medium which has a large storage capacity has been widely used in order to back up large amounts of data. The tape library system includes a library device that has a plurality of storage slots which store tape media, and a robot which transports a tape medium from a storage slot to a physical drive. For example, when a backup process is performed, the robot of the library device ejects a tape medium from a storage slot, and mounts the ejected tape medium on the physical drive. Then, backup target data is written in the tape medium through the physical drive. As above, in the tape library system, it takes a certain amount of time in order to mount the tape medium when the backup process is performed.

In recent years, a virtual library system is proposed which reduces the time that is taken to mount a tape medium and which causes data to be written or read at high speed, by using a disk array which allows access to data stored therein at high speed. The virtual library system arranges a virtual tape device, which includes the disk array, between a host computer and a library device, and virtually treats the reading or writing performed on a logical volume of the disk array as the reading or writing performed on the tape medium. Data of the logical volume is written from the disk array to the tape medium of the library device by the virtual tape device at a specific timing. The writing performed on the tape medium may be referred to as migration.

The logical volume and the logical drive on which the logical volume is mounted are constructed on the disk array. Therefore, it is possible to realize the reading or writing of data at high speed without performing a physical mounting operation. Since the disk array, data of which may be accessed at high speed compared to the tape medium, is used, it is apparent that it is also possible to reduce time that is taken to perform a process to read and write data.

In addition, the virtual tape device includes a function (hereinafter, referred to as an export function) of writing the data of the logical volume in the tape medium in accordance with an instruction received from the host computer and enabling the tape medium to be exported from the library device. The export function is used, for example, when the logical volume is moved in such a way that the tape medium on which the data of the logical volume is written is transported to another center and the data of the logical volume is read by the virtual tape device installed in that center. Such a movement of the logical volume is performed, for example, in order to synchronize data of logical volumes managed by virtual tape devices or library devices of different centers.

In the virtual library system, there is a case where an approach is adopted in which a plurality of centers respectively installed with a library device and a virtual tape device are arranged in separated regions, and data of logical volumes is synchronized between the plurality of centers. According to the approach, the data of the logical volumes is synchronized between the centers, and the virtual tape device and the library device are redundant. As a result, it is possible to reduce data loss due to a disaster or the like. For example, the synchronization of the logical volume using the export function is used to secure such redundancy.

In addition, in recent years, a method is proposed in which data is directly copied using a network to a tape medium of a library device installed in another center. This copying method may be referred to as remote copying. The remote copying is performed through a network in such a way that a virtual tape device installed in a copying source center directly writes data of a logical volume in a tape medium of a library device installed in another center. Therefore, it is possible to suppress difference in synchronization data from being generated between both centers due to time lag that is generated because of the transportation of the tape medium. In addition, there is an advantage in that the load of a virtual tape device installed in another center is not increased when the remote copying is performed and influence on tasks in that center is small.

Further, a remote backup system is proposed which transmits, without passing through the host computer, data in order to multiplex data to a magnetic tape library device from a disk sub system that records data received from the host computer. In addition, a backup device is proposed which multiplexes a data copying process and realizes backup at high speed.

Related techniques are discussed in, for example, International Publication Pamphlet No. WO2009/040954, Japanese Laid-open Patent Publication No. 11-102262, and Japanese Laid-open Patent Publication No. 2005-18484.

In order to recognize a logical volume in a tape medium, the virtual tape device uses recognition information (hereinafter, referred to as directory (DIR) information) which includes information, such as the number of logical volumes in the tape medium or the total amount of data. For example, when a tape medium exported using the export function is imported to a library device installed in another center, the virtual tape device recognizes a logical volume based on the DIR information recorded in the tape medium. Therefore, when the data of the logical volume is written in the tape medium using the export function, the virtual tape device records the DIR information in the tape medium. The remote copying is performed in the same manner.

The DIR information is recorded in the tape medium after entire data of a writing target logical volume is written on the tape medium. Therefore, when the remote copying is used, the DIR information is not recorded on the tape medium if data of a part of the writing target logical volume is not written on the tape medium because of network failure or the like. In this case, the data of the logical volume written halfway on the tape medium is not recognized by the virtual tape device. Therefore, after restoration, the remote copying is performed again on data including the data of the logical volume which has been written in the tape medium.

Although the tape medium is described as an example of the portable recording medium, the embodiments are the same as in a case where a recording medium other than the tape medium is used.

### SUMMARY

According to an aspect of the present invention, provided is a data management device including a processor. The processor is configured to transmit data of a logical volume to a library device different from the data management device so as to record the data of the logical volume on a portable recording medium managed by the library device. The processor is configured to prepare recognition information whenever data of a logical volume is recorded on the portable recording medium. The recognition information is used to recognize entire first logical volumes. Data of the first logical volumes is recorded on the portable recording medium. The processor is configured to transmit the recognition information to the library device so as to record the recognition information on the portable recording medium.

The objects and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a system which includes a data management device according to a first embodiment;

FIG. 2 is a diagram illustrating an example of a virtual tape library system according to a second embodiment;

FIG. 3 is a sequence diagram illustrating an example of a flow of an export process performed in a virtual tape library system according to the second embodiment;

FIG. 4 is a sequence diagram illustrating an example of a flow of remote copying performed in a virtual tape library system according to the second embodiment;

FIG. 5 is a diagram illustrating an example of hardware of a host computer according to the second embodiment;

FIG. 6 is a diagram illustrating an example of a data structure of data stored in a disk array according to the second embodiment;

FIG. 7 is a diagram illustrating an example of hardware (appearance of housing) of a library device according to the second embodiment;

FIG. 8 is a diagram illustrating an example of hardware (inside of housing) of a library device according to the second embodiment;

FIG. 9 is a diagram illustrating an example of hardware (robot) of a library device according to the second embodiment;

FIG. 10 is a diagram illustrating an example of hardware (hand mechanism) of a library device according to the second embodiment;

FIG. 11 is a diagram illustrating an example of hardware of a tape cartridge according to the second embodiment;

FIG. 12 is a diagram illustrating an example of a data format (for a virtual tape device) of data recorded in a magnetic tape of a tape cartridge according to the second embodiment;

FIG. 13 is a diagram illustrating an example of DIR information recorded in a magnetic tape of a tape cartridge according to the second embodiment;

FIG. 14 is a diagram illustrating an example of a data format (for a non-virtual tape device) of data recorded in a magnetic tape of a tape cartridge according to the second embodiment;

FIG. 15 is a block diagram illustrating an example of functions of a server device according to the second embodiment;

FIG. 16 is a diagram illustrating an example of management information managed by a server device according to the second embodiment;

FIG. 17 is a diagram illustrating an example of functions of a controller according to the second embodiment;

FIG. 18 is a first diagram illustrating a remote copying process when DIR information is prepared after data of entire writing target logical volumes is written in a magnetic tape;

FIG. 19 is a second diagram illustrating a remote copying process when DIR information is prepared after data of entire writing target logical volumes is written in a magnetic tape;

FIG. 20 is a diagram illustrating a remote copying process when a method of preparing DIR information according to the second embodiment is applied;

FIG. 21 is a first flowchart illustrating a flow of a process performed by a virtual tape device on a side that transmits data of a logical volume according to the second embodiment when remote copying is performed;

FIG. 22 is a second flowchart illustrating a flow of a process performed by a virtual tape device on a side that transmits data of a logical volume according to the second embodiment when remote copying is performed;

FIG. 23 is a first flowchart illustrating a flow of a DIR information activation process performed by a virtual tape device on a side that receives data of a logical volume according to the second embodiment;

FIG. 24 is a second flowchart illustrating a flow of a DIR information activation process performed by a virtual tape device on a side that receives data of a logical volume according to the second embodiment; and

FIG. 25 is a flowchart illustrating a flow of a process performed when an interrupted remote copying is restarted by a virtual tape device on a side that transmits data of a logical volume according to the second embodiment.

### DESCRIPTION OF EMBODIMENTS

Hereinafter, embodiments of the disclosure will be described with reference to the accompanying drawings. In the specification and the drawings, the same reference numeral indicates components having substantially the same function, and thus the description may not be repeated.

### First Embodiment

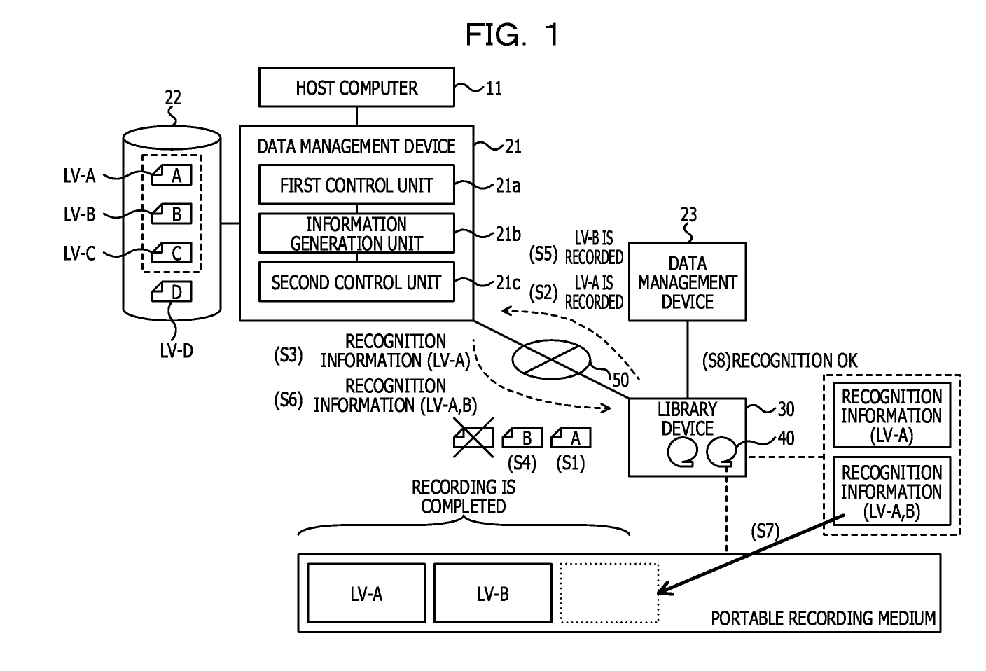

A first embodiment will be described with reference to FIG. 1. FIG. 1 is a diagram illustrating an example of a system which includes a data management device according to the first embodiment.

As depicted in FIG. 1, the system according to the first embodiment includes a host computer 11, a data management device 21, a storage device 22, and another data management device 23. The system further includes a library device 30, a portable recording medium 40, and a network 50. The data management device 21 is connected to the library device 30 through the network 50. The network 50 is constructed using, for example, a wired line, a wireless line, a router which connects lines to each other, combinations thereof, and the like. The portable recording medium 40 includes, for example, a magnetic recording media, an optical recording media, a magneto-optical recording media, a semiconductor memory, and the like.

The host computer 11 requests the data management device 21, for example, to perform a process. In this case, the data management device 21 which receives the request performs the process in accordance with the request received from the host computer 11. For example, the data management device 21 performs a process to record data of logical volumes LV-A, LV-B, and LV-C from among logical volumes LV-A, . . . , LV-D stored in the storage device 22 into the portable recording medium 40 of the library device 30. Hereinafter, the process will be described as an example. In the description, the logical volumes LV-A, LV-B, and LV-C may be referred to as record targets.

The data management device 21 includes a first control unit 21a, an information generation unit 21b, and a second control unit 21c.

The data management device 21 may include a volatile storage device (not depicted in the drawing) such as a random access memory (RAM) or a non-volatile storage device (not depicted in the drawing) such as a hard disk drive (HDD) or a flash memory. The first control unit 21a, the information generation unit 21b, and the second control unit 21c may be a processor such as a central processing unit (CPU) or a digital signal processor (DSP). The first control unit 21a, the information generation unit 21b, and the second control unit 21c may be an electronic circuit such as an application specific integrated circuit (ASIC) or a field programmable gate array (FPGA) other than the processor. The first control unit 21a, the information generation unit 21b, and the second control unit 21c execute, for example, a program stored in a memory unit in the data management device 21 or another memory.

The first control unit 21a transmits the data of the logical volumes LV-A, LV-B, and LV-C to the library device 30 connected through the network 50. Further, the first control unit 21a stores the data of the logical volumes LV-A, LV-B, and LV-C in the portable recording medium 40 of the library device 30. The information generation unit 21b generates recognition information whenever data of a logical volume is recorded in the portable recording medium 40. The recognition information is used to recognize entire logical volumes, data of which has been recorded in the portable recording medium 40. The second control unit 21c transmits the recognition information to the library device 30 and records the recognition information in the portable recording medium 40.

In the example of FIG. 1, the first control unit 21a transmits the data of the logical volume LV-A to the library device 30 through the network 50 (S1). In the example, the data of the logical volume LV-A is received by the library device 30 and is recorded in the portable recording medium 40. If the data of the logical volume LV-A is recorded in the portable recording medium 40, a notification that the data of the logical volume LV-A has been recorded is transmitted from the library device 30 to the data management device 21 (S2). The information generation unit 21b which receives the notification generates recognition information (LV-A) corresponding to the logical volume (LV-A), data of which has been recorded in the portable recording medium 40. The second control unit 21c transmits the recognition information (LV-A) to the library device 30 (S3).

The recognition information (LV-A) is temporarily maintained by the library device 30. The first control unit 21a transmits the data of the logical volume LV-B to the library device 30 (S4). In the example, the data of the logical volume LV-B is received by the library device 30 and is recorded in the portable recording medium 40. If the data of the logical volume LV-B is recorded in the portable recording medium 40, a notification that the data of the logical volume LV-B has been recorded is transmitted from the library device 30 to the data management device 21 (S5). The information generation unit 21b which receives the notification generates recognition information (LV-A, B) corresponding to the entire logical volumes (LV-A, LV-B), data of which has been recorded in the portable recording medium 40. The second control unit 21c transmits the recognition information (LV-A, B) to the library device 30 (S6).

The recognition information (LV-A, B) is temporarily maintained by the library device 30. The first control unit 21a transmits the data of the logical volume LV-C to the library device 30. However, in the example, the data of the logical volume LV-C is not received by the library device 30 due to failure of the network 50 or the like. In this case, the library device 30 records, under the control of the data management device 23, the latest recognition information (LV-A, B), which is temporarily maintained, into the portable recording medium 40 (S7). Control for recording the recognition information (LV-A, B) in the portable recording medium 40 may be performed by another device other than the data management device 23.

As described above, if the recognition information (LV-A, B) is recorded in the portable recording medium 40, the data management device 23 may recognize the logical volumes LV-A and LV-B which have been recorded in the portable recording medium 40 (S8). Therefore, even when a part of the record targets is not recorded in the portable recording medium 40 due to the failure of the network 50 or the like, it is possible to use the data of the logical volumes LV-A and LV-B which have already been recorded.

### Second Embodiment

Subsequently, a second embodiment will be described.

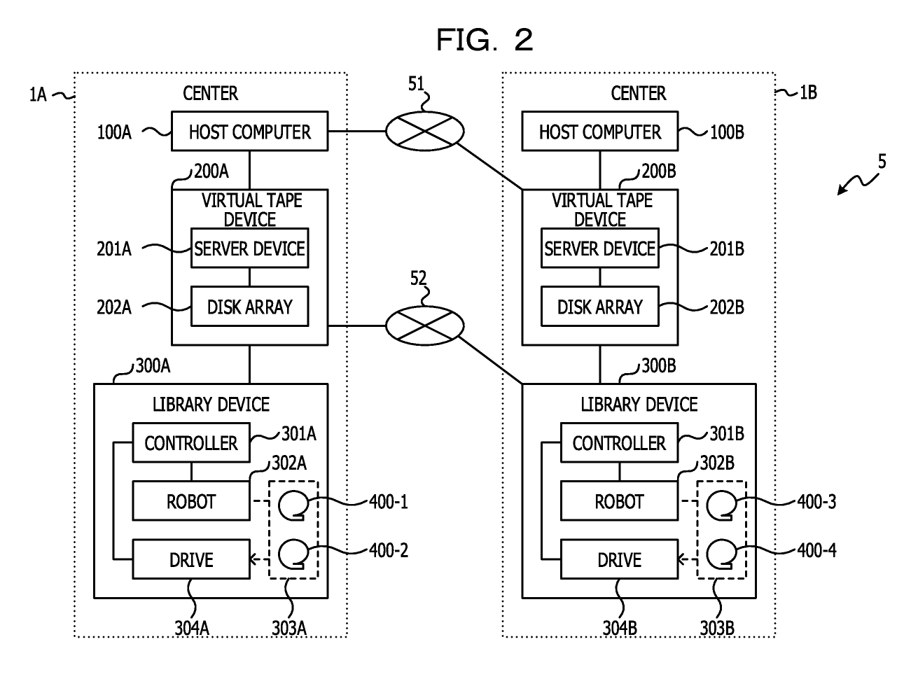

First, a virtual tape library system 5 according to the second embodiment will be described with reference to FIG. 2. FIG. 2 is a diagram illustrating an example of a virtual tape library system according to the second embodiment.

As depicted in FIG. 2, the virtual tape library system 5 is a system in which centers 1A and 1B are connected with each other through networks 51 and 52. In the example of FIG. 2, a host computer 100A, a virtual tape device 200A, and a library device 300A are installed in the center 1A. A host computer 100B, a virtual tape device 200B, and a library device 300B are installed in the center 1B.

The host computer 100A performs a data reading or writing process with regard to the virtual tape device 200A. For example, the host computer 100A transmits backup target data to the virtual tape device 200A, and writes the data in the virtual tape device 200A. The host computer 100A reads data that is backed up in the virtual tape device 200A. The host computer 100A requests the virtual tape device 200A to perform an export process, a remote copying process or the like which will be described later.

The virtual tape device 200A includes a server device 201A and a disk array 202A. The disk array 202A is an example of a storage device, data of which may be accessed at high speed. The disk array 202A is, for example, a storage device that is constructed as redundant arrays of inexpensive disks (RAID) using a plurality of physical disks.

The physical disks of the disk array 202A are respectively managed in units called a volume group (VG). Virtual partitions are logically set on the volume group, and data is written or read while treating the virtual partitions as physical disks. The virtual partitions are referred to as logical volumes (LVs). If a logical volume is mounted on a logical drive, which is logically set to be treated as a physical drive, the data may be accessed.

The server device 201A manages the logical volumes. For example, when the server device 201A receives a data writing request from the host computer 100A, the server device 201A mounts a logical volume of a writing target, on a logical drive and writes data received from the host computer 100A into the logical volume.

If the server device 201A receives a data reading request from the host computer 100A, the server device 201A mounts a logical volume of a reading target, on a logical drive, reads data from the logical volume, and transmits the read data to the host computer 100A. In addition, the server device 201A performs, at the request of the host computer 100A, an export process, a remote copying process or the like which will be described later.

The library device 300A includes a controller 301A, a robot 302A, a cell 303A, and a drive 304A. The controller 301A controls the operation of the robot 302A. In addition, the controller 301A writes data in a tape cartridge 400 (400-1 or 400-2 in the example of FIG. 2) mounted on the drive 304A. Further, the controller 301A reads data from a tape cartridge 400 (400-1 or 400-2 in the example of FIG. 2) mounted on the drive 304A.

The robot 302A ejects a tape cartridge 400 (400-1 or 400-2 in the example of FIG. 2) from the cell 303A and transports the tape cartridge 400 to the drive 304A under the control of the controller 301A. The robot 302A transports the tape cartridge 400 (400-1 or 400-2 in the example of FIG. 2) from the drive 304A to the cell 303A under the control of the controller 301A. The cell 303A is a storage space where tape cartridges 400 (400-1 and 400-2 in the example of FIG. 2) are stored.

In the example of FIG. 2, the functions of the host computer 100B, the virtual tape device 200B, and the library device 300B are the same as the respective functions of the host computer 100A, the virtual tape device 200A, and the library device 300A described above.

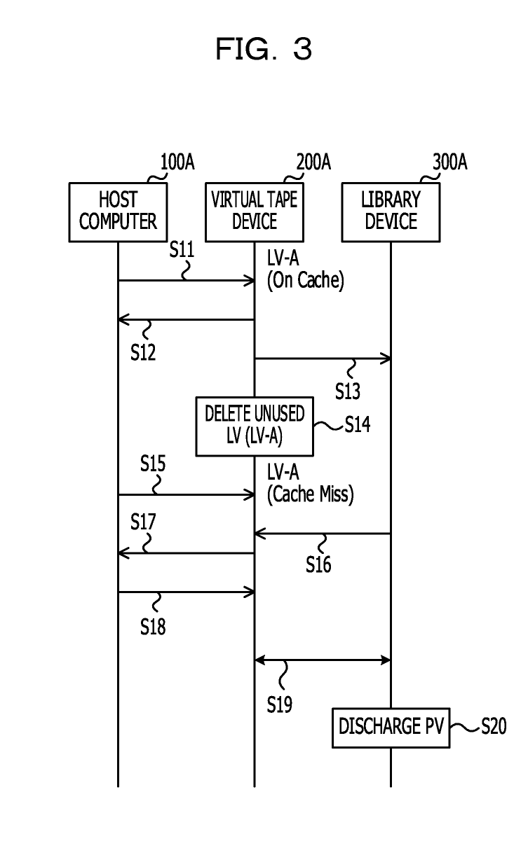

Here, an export process will be described with reference to FIG. 3. Although an example of an export process performed by the host computer 100A, the virtual tape device 200A, and the library device 300A will be described, the export process is the same as an export process performed by the host computer 100B, the virtual tape device 200B, and the library device 300B.

FIG. 3 is a sequence diagram illustrating an example of a flow of an export process performed in the virtual tape library system according to the second embodiment. The tape cartridge 400 may be referred to as a physical volume (PV) in the description below or in the drawing. In the example of FIG. 3, a flow of a process including data access to the logical volume is described for convenience of explanation.

The export process is a process of writing data of a logical volume, which is stored in the disk array 202A, into the tape cartridge 400 such that the data of the logical volume may be discharged to the outside of the library device 300A. Hereinafter, the export process will be further described.

When a data reading or writing request for the logical volume LV-A is received from the host computer 100A (S11), the server device 201A mounts the logical volume LV-A on a logical drive. A state in which the reading or writing target logical volume LV-A is present in the disk array 202A may be referred to as On Cache. A state in which the reading or writing target logical volume LV-A is not present in the disk array 202A may be referred to as Cache Miss. A process in the state of Cache Miss will be described later.

When the request made by the host computer 100A is a reading request, the server device 201A transmits the data of the logical volume LV-A to the host computer 100A at the reading request (S12). When the request made by the host computer 100A is a writing request, the server device 201A records data received from the host computer 100A in the logical volume LV-A at the writing request. The processes in S11 and S12 are appropriately performed at the request of the host computer 100A.

When preset conditions are satisfied, the server device 201A writes the data of the logical volume LV-A, which is stored in the disk array 202A, into a tape cartridge 400 of the library device 300A (S13). The process may be referred to as a migration process. The preset conditions may include, for example, that data access with regard to the logical volume LV-A is not performed beyond a preset period and that the usage rate of the disk array 202A or the amount of used data in the disk array 202A exceeds a preset value. Here, for convenience of explanation, description will be made while assuming a case where the migration process is performed with regard to a logical volume that is not used for a fixed period.

After the migration process is completed, the server device 201A deletes the data of the logical volume LV-A, which is not used, from the disk array 202A (S14). With the process, it is possible to effectively use the disk array 202A.

When a reading or writing request for the logical volume LV-A is received from the host computer 100A after the data of the logical volume LV-A is deleted (S15), the logical volume LV-A is not present in the disk array 202A, and thus the state becomes Cache Miss. In this case, the server device 201A reads the data of the logical volume LV-A from the library device 300A and stores the read data in the disk array 202A (S16). Further, the server device 201A mounts the logical volume LV-A on a logical drive.

When the request made by the host computer 100A is a reading request, the server device 201A transmits the data of the logical volume LV-A to the host computer 100A at the reading request (S17). When the request made by the host computer 100A is a writing request, the server device 201A records data received from the host computer 100A in the logical volume LV-A at the writing request. The processes in S15 and S17 are appropriately performed at the request of the host computer 100A.

When an export request for the logical volume LV-A is received from the host computer 100A (S18), the server device 201A performs the export process (S19). The server device 201A writes the data of the logical volume LV-A, which is stored in the disk array 202A, into a tape cartridge 400 of the library device 300A. The server device 201A controls the library device 300A to discharge the tape cartridge 400 in which the data of the logical volume LV-A is written from the library device 300A to the outside of a housing.

The library device 300A discharges the tape cartridge 400 in which the data of the logical volume LV-A is recorded to the outside under the control of the server device 201A (S20).

The discharged tape cartridge 400 is transported to, for example, the center 1B and is inserted into the library device 300B. The logical volume LV-A is activated by the virtual tape device 200B such that the server device 201B reads the data of the logical volume LV-A from the tape cartridge 400. If the logical volume LV-A is activated, the virtual tape device 200B may store the data of the logical volume LV-A in the disk array 202B and to use the data. The process of enabling the data of the logical volume LV-A to be used may be referred to as an import process.

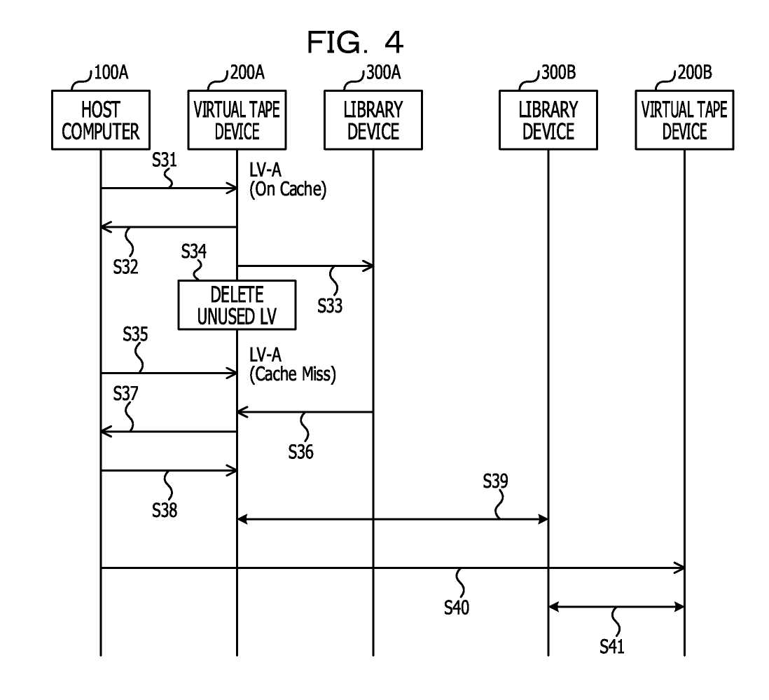

Subsequently, the remote copying will be described with reference to FIG. 4. If the remote copying is used, it is possible to use the data of the logical volume LV-A in the center 1B while the tape cartridge 400 is not transported. FIG. 4 is a sequence diagram illustrating an example of a flow of the remote copying performed in the virtual tape library system according to the second embodiment. In the example of FIG. 4, for convenience of explanation, a flow of a process including data access to a logical volume is described. Since processes in S31 to S37 are the same as S11 to S17 of FIG. 3, the processes in S31 to S37 will not be described in detail.

The remote copying is a process of the server device 201A of the virtual tape device 200A to directly write the data of the logical volume LV-A into the tape cartridge 400 of library device 300B in the center 1B. At this time, the server device 201A transmits the data of the logical volume LV-A to the library device 300B through the network 52, and writes the data into the tape cartridge 400 of the library device 300B.

The host computer 100A requests the server device 201A to perform remote copying of the data of the logical volume LV-A to the library device 300B (S38). The server device 201A which receives the request transmits the data of the logical volume LV-A, which is stored in the disk array 202A, to the library device 300B, and writes the data in the tape cartridge 400 (S39). When the writing process is completed, the server device 201A notifies the host computer 100A of the completion of the writing process.

The host computer 100A accesses the server device 201B of the virtual tape device 200B installed in the center 1B, and requests to perform the import process with regard to the remote copied logical volume LV-A (S40). At this time, the host computer 100A transmits the request for the import process to the virtual tape device 200B through the network 51.

The virtual tape device 200B which receives the request for the import process activates the logical volume LV-A, data of which is recorded in the tape cartridge 400 of the library device 300B (S41). Then, the virtual tape device 200B performs the import process with regard to the activated data of the logical volume LV-A.

As described above, in the virtual tape library system 5, it is possible to move data of a logical volume between the centers using the export process and the remote copying. Therefore, it is possible to easily synchronize the data of the logical volumes between the centers. A labor and time that is required to transport the tape cartridge 400 is reduced using the remote copying. Using the export process, it is possible to move data of a logical volume with regard to centers which do not correspond to the remote copying.

Hereinabove, the virtual tape library system 5 has been described.

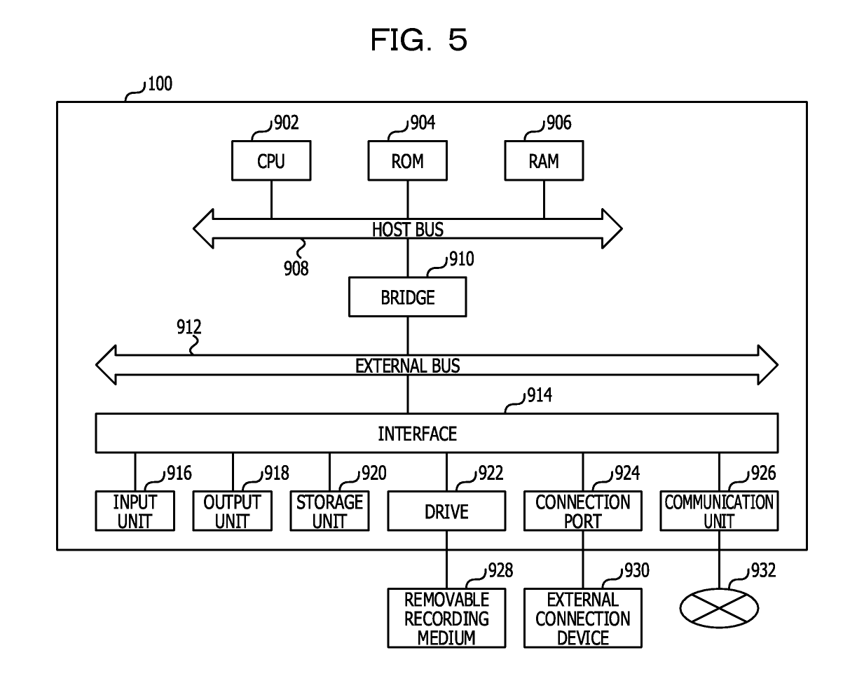

Subsequently, hardware of devices included in the virtual tape library system 5, a data format used in the virtual tape library system 5, and the like will be described with reference to FIGS. 5 to 14.

The host computers 100A and 100B may not be distinguished from each other and each may be referred to as a host computer 100 for simplification. In the same manner, each of the virtual tape devices 200A and 200B may be referred to as a virtual tape device 200, each of the library devices 300A and 300B may be referred to as a library device 300, and each of the tape cartridges 400-1, . . . , and 400-4 may be referred to as a tape cartridge 400. Each of the server devices 201A and 201B may be referred to as a server device 201 and each of the disk arrays 202A and 202B may be referred to as a disk array 202. Each of the controllers 301A and 301B may be referred to as a controller 301, each of the robots 302A and 302B may be referred to as a robot 302, each of the cells 303A and 303B may be referred to as a cell 303, and each of the drives 304A and 304B may be referred to as a drive 304.

Hardware of the host computer 100 will be described. It is possible to realize functions of the host computer 100 using, for example, hardware resources of an information processing device depicted in FIG. 5. That is, the functions of the host computer 100 are realized by executing a computer program for controlling the hardware depicted in FIG. 5. FIG. 5 is a diagram illustrating an example of hardware of a host computer according to the second embodiment.

As depicted in FIG. 5, the hardware includes a CPU 902, a read only memory (ROM) 904, a RAM 906, a host bus 908, and a bridge 910. Further, the hardware includes an external bus 912, an interface 914, an input unit 916, an output unit 918, a storage unit 920, a drive 922, a connection port 924, and a communication unit 926.

The CPU 902 functions as, for example, an arithmetic processing unit or a control unit, and controls the entirety or a part of operations of each component in accordance with various programs recorded in the ROM 904, the RAM 906, the storage unit 920, or a removable recording medium 928. The ROM 904 is an example of a storage device which stores therein a program read by the CPU 902 and data used for operations, or the like. A program read by the CPU 902, various parameters which change when the program is executed, and the like are temporarily or permanently stored in the RAM 906, for example.

These components are connected to each other via, for example, a host bus 908 capable of transmitting data at high speed. The host bus 908 is connected via, for example, the bridge 910 to the external bus 912, the data transmission speed of which is relatively low. A mouse, a keyboard, a touch panel, a touch pad, a button, a switch, a lever, or the like is used as the input unit 916, for example. A remote controller, which is capable of transmitting a control signal using infrared rays or other radio waves, may be used as the input unit 916.

A display device, such as a cathode ray tube (CRT), a liquid crystal display (LCD), a plasma display panel (PDP), or an electro-luminescence display (ELD), is used as the output unit 918, for example. An audio output device such as a speaker or a headphone, a printer, or the like may be used as the output unit 918. That is, the output unit 918 is a device capable of visually or audibly outputting information.

The storage unit 920 is a device to store therein various data. A magnetic storage device, such as an HDD, is used as the storage unit 920, for example. A semiconductor device, such as a solid state drive (SSD) or a RAM disk, an optical storage device, a magneto-optical storage device, or the like may be used as the storage unit 920.

The drive 922 is a device which reads information recorded in the removable recording medium 928 that is a detachable recording medium or writes information in the removable recording medium 928. A magnetic disk, an optical disc, a magneto-optical disk, a semiconductor memory, or the like is used as the removable recording medium 928, for example.

The connection port 924 is a port to connect with an external connection device 930, and examples include a universal serial bus (USB) port, an IEEE1394 port, a small computer system interface (SCSI), an RS-232C port, and an optical audio terminal. A printer or the like is used as the external connection device 930, For example.

The communication unit 926 is a communication device to connect with a network 932. A communication circuit for a wired or wireless local area network (LAN), a communication circuit for wireless USB (WUSB), a communication circuit or a router for optical communication, a communication circuit or a router for asymmetric digital subscriber line (ADSL), or a communication circuit for a mobile phone network is used as the communication unit 926, for example. The network 932 is connected to the communication unit 926 in a wired or wireless manner, and includes, for example, the Internet, a LAN, a broadcasting network, a satellite communication channel, or the like.

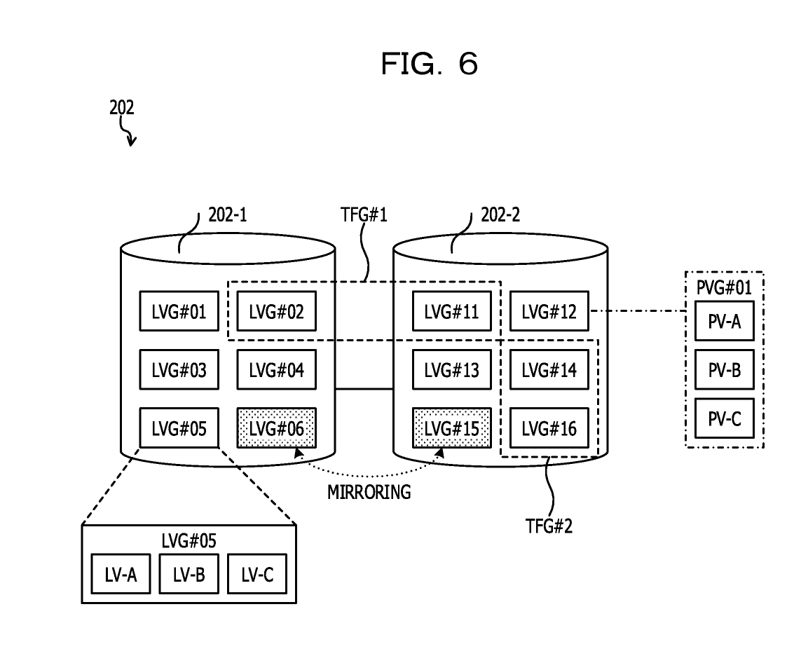

Subsequently, hardware of the server device 201 and a data structure of a logical volume stored in the disk array 202 will be described. The hardware of the server device 201 is the same as the above-described hardware of the host computer 100. Accordingly, it is possible to realize the functions of the server device 201 using the hardware depicted in FIG. 5. The disk array 202 connects, for example, a plurality of storage devices such as HDDs and the SSDs. In an example of FIG. 6, the disk array 202 including two storage devices 202-1 and 202-2 connected with each other is depicted.

In the disk array 202 included in the virtual tape device 200, the logical volumes are managed based on a data structure as depicted in FIG. 6. FIG. 6 is a diagram illustrating an example of a data structure of data stored in the disk array according to the second embodiment. The virtual tape device 200 may define arbitrary physical volumes as a tape file system group (TFG) when setting a file system in the disk array 202. A physical volume that is not defined as the TFG is treated as a floating area. In the example of FIG. 6, two TFGs TFG#1 and TFG#2 are defined and the other areas are treated as floating areas.

A logical volume group (LVG) to which each logical volume LV stored in the disk array 202 belongs may be defined. In the example of FIG. 6, LVG#01 to LVG#06 are stored in the storage device 202-1, and LVG#11 to LVG#16 are stored in the storage device 202-2. Three logical volumes LV-A, LV-B, and LV-C belong to the LVG#05. An LVG may be assigned to a TFG. In the example of FIG. 6, the LVG#02 and the LVG#11 are assigned to the TFG#1, and the LVG#14 and the LVG#16 are assigned to the TFG#2. The floating areas are used for the other LVGs.

Mirroring may be set in LVG units. In the example of FIG. 6, setting is made such that mirroring is performed on the LVG#06 and the LVG#15. The physical volumes may be managed using a physical volume group (PVG) similarly to the LVG. Link relationships may be arbitrarily set between LVGs and PVGs. In the example of FIG. 6, a link relationship between the PVG#01 and the LVG#12 is set. In this case, if data of an LV which belongs to the LVG#12 is updated, data acquired after the update is performed is written in a PV which belongs to the PVG#01. Management information used for management by the server device 201 is also recorded in the disk array 202.

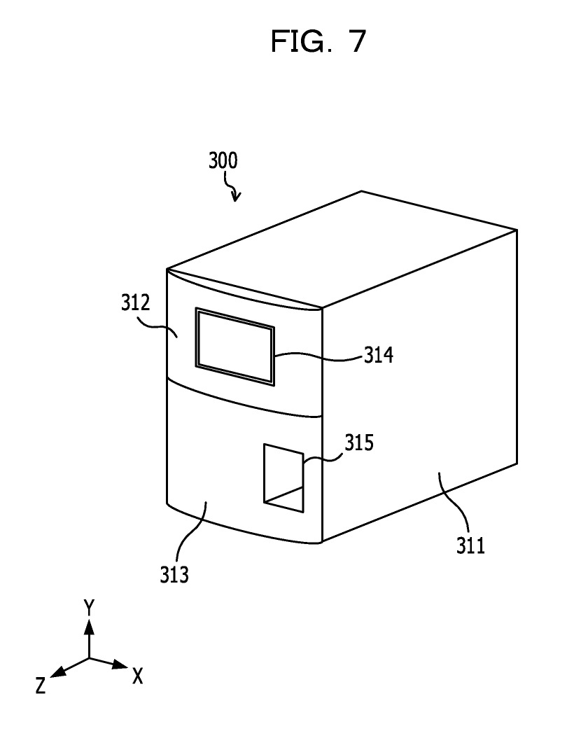

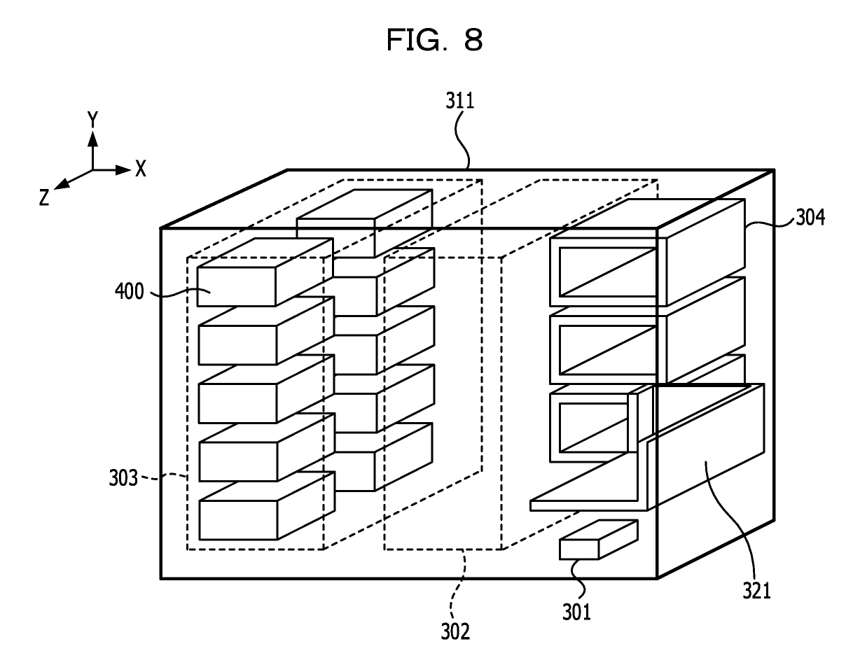

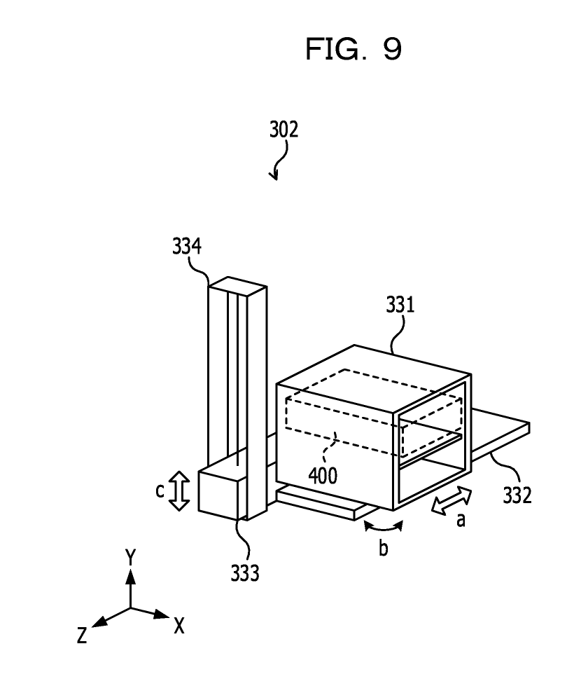

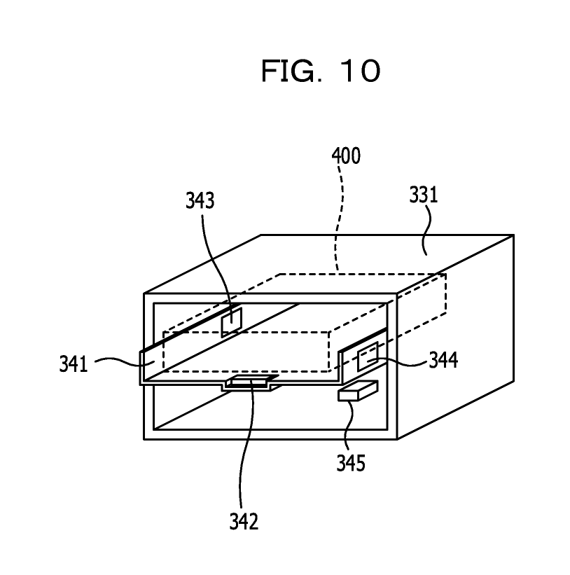

Subsequently, hardware of the library device 300 will be described with reference to FIGS. 7 to 10. FIG. 7 is a diagram illustrating an example of hardware (appearance of the housing) of a library device according to the second embodiment. FIG. 8 is a diagram illustrating an example of hardware (inside of the housing) of a library device according to the second embodiment. FIG. 9 is a diagram illustrating an example of hardware (robot) of a library device according to the second embodiment. FIG. 10 is a diagram illustrating an example of hardware (hand mechanism) of a library device according to the second embodiment.

The library device 300 has, for example, an external appearance of a housing 311 as depicted in FIG. 7. The housing 311 includes an upper front door 312, a lower front door 313, an operator panel 314, and a cartridge mouth 315. The upper front door 312 is a door which may be opened without inserting a key. A power switch (not depicted in the drawing) may be mounted on the upper front door 312.

The lower front door 313 is a door that is open when the tape cartridge 400 is directly deposited or withdrawn without using the robot 302 or when maintenance is performed on the robot 302. The lower front door 313 is a door which includes a key hole (not depicted in the drawing) and which may be opened by inserting a key. The operator panel 314 is a display panel which displays device information of the library device 300. The operator panel 314 has a function of a touch panel capable of inputting information by performing a touch operation. For example, the operator panel 314 may be used when an instruction is given to the library device 300.

The cartridge mouth 315 is a mechanism which functions as an entrance that is used when the tape cartridge 400 is inserted or discharged. When the export process is performed, the tape cartridge 400 is ejected from the cartridge mouth 315. When the tape cartridge 400 transported from another center is inserted into the library device 300, an insertion operation is performed through the cartridge mouth 315.

The inside of the housing 311 has, for example, a structure as depicted in FIG. 8. A cartridge input/output mechanism 321 is provided inside the housing 311 in addition to the controller 301, the robot 302, the cell 303, and the drive 304. Tape cartridges 400 are stored in the cell 303. The cartridge input/output mechanism 321 may be referred to as a cartridge access station (CAS). The cartridge input/output mechanism 321 is provided in a position corresponding to the cartridge mouth 315.

The drive 304 is a physical drive to read or write data. If the tape cartridge 400 is mounted on the drive 304, data may be read or written from or to the tape cartridge 400 through the drive 304. The robot 302 is a mechanism that transports a tape cartridge 400 stored in the cell 303 to the drive 304. The robot 302 is also a mechanism that transports a tape cartridge 400 from the drive 304 to the cell 303. Further, when the export process is performed, the robot 302 transports a target tape cartridge 400 to the cartridge input/output mechanism 321.

The robot 302 has, for example, a structure as depicted in FIG. 9. The robot 302 includes a hand mechanism 331, a Z mechanism 332, a Y mechanism 333, and a Y support 334.

The hand mechanism 331 is a mechanism that grasps a tape cartridge 400. The Z mechanism 332 is a mechanism that moves the hand mechanism 331 in the Z-axis direction (in the direction of an arrow “a”) of FIG. 9. In addition, a swivel mechanism (not depicted in the drawing) is provided between the hand mechanism 331 and the Z mechanism 332, and the hand mechanism 331 may rotate within a Z-X plane (in the direction of an arrow “b”). The Y mechanism 333 is a mechanism that moves the hand mechanism 331 in the Y-axis direction (in the direction of an arrow “c”). The Y mechanism 333 moves while being guided by the Y support 334.

The hand mechanism 331 has, for example, a structure as depicted in FIG. 10. The hand mechanism 331 includes a cartridge grasping mechanism 341, a cartridge in cell (CIC) sensor 342, a cartridge memory (CM) reader/writer 343, a cartridge in picker (CIP) sensor 344, and a label reader 345.

The cartridge grasping mechanism 341 is a mechanism that grasps a tape cartridge 400. The CIC sensor 342 is a sensor that recognizes whether or not a tape cartridge 400 is present in the cell 303, the cartridge input/output mechanism 321, or the drive 304. The CM reader/writer 343 is a reader/writer to read or write information from or to a cartridge memory included in a tape cartridge 400. The CIP sensor 344 is a sensor that recognizes whether or not a tape cartridge 400 is present in the hand mechanism 331. The label reader 345 is a reader that reads information written in a label of a tape cartridge 400. The label reader 345 may include a detection function to detect the position of the robot 302.

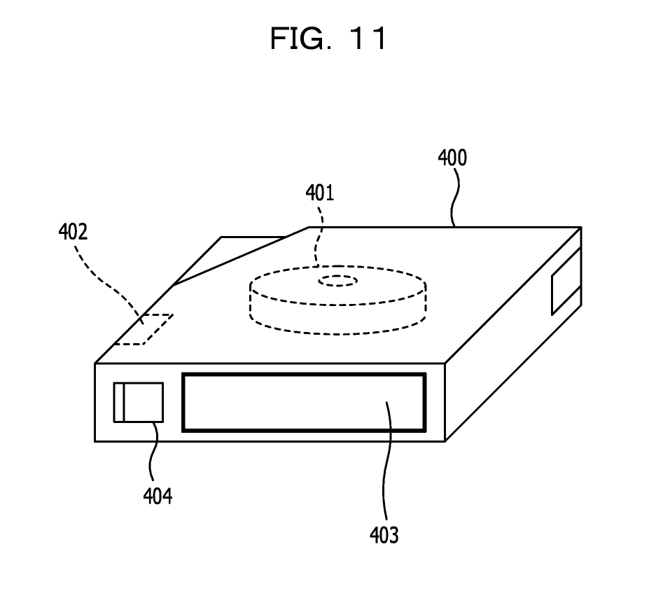

Subsequently, hardware and a data format of the tape cartridge 400 will be described with reference to FIGS. 11 to 14.

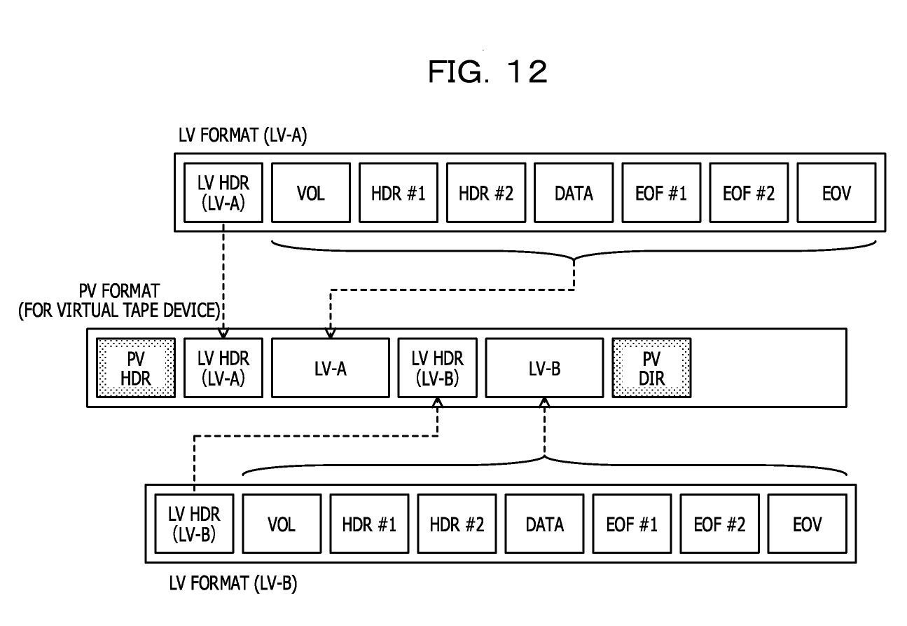

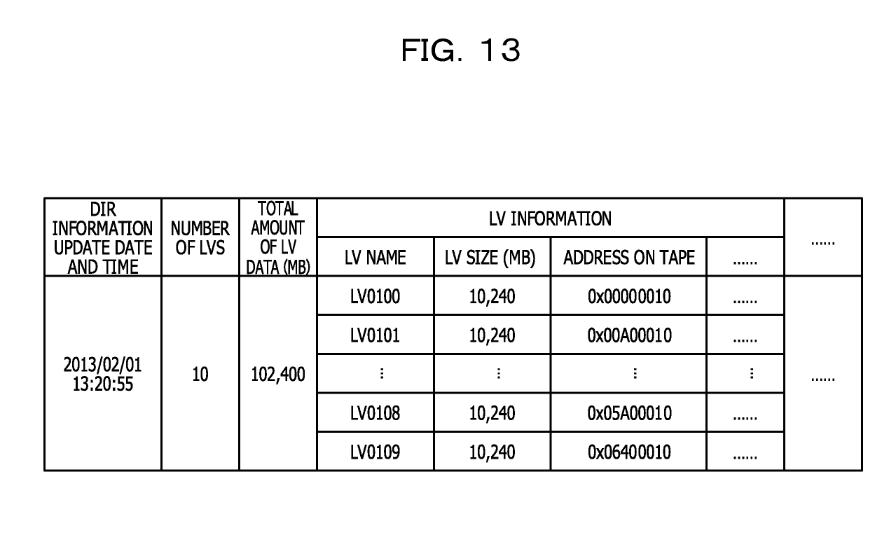

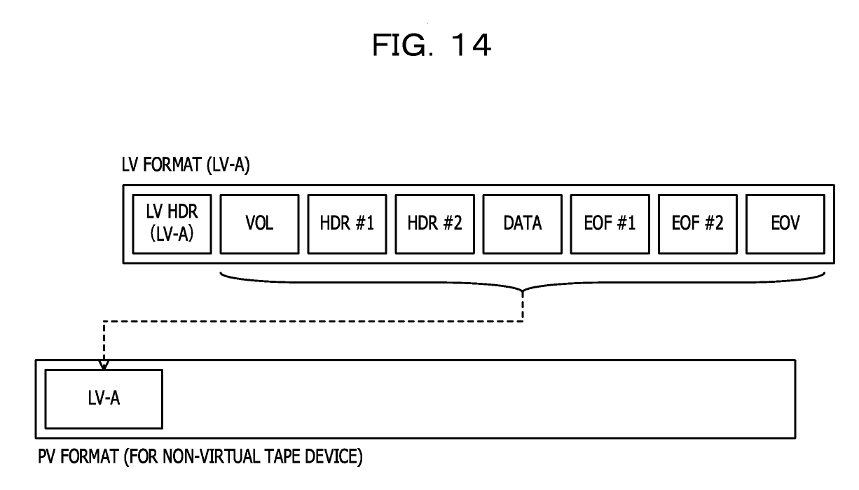

FIG. 11 is a diagram illustrating an example of hardware of a tape cartridge according to the second embodiment. FIG. 12 is a diagram illustrating an example of a data format (for a virtual tape device) of data recorded in a magnetic tape of a tape cartridge according to the second embodiment. FIG. 13 is a diagram illustrating an example of DIR information recorded in a magnetic tape of a tape cartridge according to the second embodiment. FIG. 14 is a diagram illustrating an example of a data format (for a non-virtual tape device) recorded in a magnetic tape of a tape cartridge according to the second embodiment.

The tape cartridge 400 has, for example, a form as depicted in FIG. 11. The tape cartridge 400 includes a magnetic tape 401, a cartridge memory 402, a label 403, and a write protection switch 404. The magnetic tape 401 is a magnetic recording medium in which the data of the logical volume is recorded. The cartridge memory 402 is an integrated circuit (IC) memory that has a contactless communication function. Management information used by the server device 201 for management is recorded in the cartridge memory 402.

The management information includes information such as a PV number, a tape library name, an affiliated PVG name, a PV state, and a data storage situation. The PV number is an example of information used to identify the tape cartridge 400. The tape library name is an example of information used to identify the library device 300 which stores therein the tape cartridge 400. The affiliated PVG name is an example of information used to identify the PVG to which the tape cartridge 400 belongs. The PV state information is information indicative of the use state of the tape cartridge 400. For example, the PV state information includes information indicative of unused, usable, and failed states. The data storage situation information includes information such as the entire capacity of the magnetic tape 401, the capacity being used, the capacity not being used, and the number of logical volumes, data of which is recorded in the magnetic tape 401.

Identification information or the like is written on the label 403 in order to identify the tape cartridge 400. The identification information is written in the form of, for example, a barcode or the like. The write protection switch 404 is a switch to limit the writing of data in the magnetic tape 401. For example, if the write protection switch 404 is turned on, it is difficult to write data in the magnetic tape 401.

Here, a data format of data recorded in the magnetic tape 401 will be described.

A data format of a logical volume LV used by the virtual tape device 200 is defined as depicted in the upper and lower portions of FIG. 12.

A volume block (VOL) is a block of 80 bytes in which a volume name, an owner name, and the like are written. A first header block (HDR#1) is a block of 80 bytes in which a file name, an update date, and the like are written. A second header block (HDR#2) is a block of 80 bytes in which a record format, a block length, and the like are written. A data block (DATA) is a block having a variable length in which user data is written.

A first end of file block (EOF#1) is a block of 80 bytes in which a file name, an update date, and the like are written. A second end of file block (EOF#2) is a block of 80 bytes in which a record format, a block length, and the like are written. An end of volume (EOV) is a mark block which indicates the end of the volume. An LV header (HDR) includes information such as a generation (the update frequency of the logical volume), an LV name (logical volume name), an LVG name (logical volume group name), an LV size (size of the data of the logical volume), and an LV preparation date (date on which the logical volume is prepared).

When the volumes LV-A and LV-B depicted in the upper and lower portions of FIG. 12 are recorded in the magnetic tape 401, the format (referred to as a PV format) of data recorded in the magnetic tape 401 becomes as in the middle portion of FIG. 12. In addition to the logical volumes LV-A and LV-B, a PV HDR and a PV DIR are recorded in the magnetic tape 401. The PV HDR includes information such as an identifier of the tape cartridge 400, a PV name (the name of the tape cartridge 400), a PVG name (affiliated PVG name), an identifier of the virtual tape device 200, and a status flag (flag indicative of normal or abnormal).

The PV DIR is a block that stores therein DIR information. The DIR information includes DIR information update date and time, the number of LVs, total amount of LV data, and LV information as depicted in FIG. 13. The DIR information update date and time indicates date and time on which the DIR information is updated. The number of LVs indicates the number of logical volumes, data of which is recorded in the magnetic tape 401. The total amount of LV data indicates the total amount of data of the entire logical volumes, which is recorded in the magnetic tape 401. The LV information includes an LV name, an LV size, and an address on a tape. The LV information is recorded for each logical volume, data of which is recorded in the magnetic tape 401. The LV name indicates a logical volume name. The LV size indicates the size of the data of the logical volume. The address on a tape indicates a position in the magnetic tape 401 at which the LV HDR is recorded.

When data is read by the virtual tape device 200, data of a logical volume is recorded in the magnetic tape 401 in the data format depicted in FIG. 12. On the other hand, when data is read by a device (for example, the tape library device or the like that is connected to a main frame) other than the virtual tape device 200, data of a logical volume is recorded in the magnetic tape 401 in the data format depicted in FIG. 14. As depicted in FIG. 14, data of a logical volume is recorded in the magnetic tape 401 without blocks such as the PV HDR or the PV DIR. When data of a logical volume is recorded in the magnetic tape 401 in the data format, it is possible to move the data of the logical volume to the tape library device or the like that is connected to the main frame.

Hereinabove, the hardware of the devices included in the virtual tape library system 5 and the data formats used in the virtual tape library system 5 have been described.

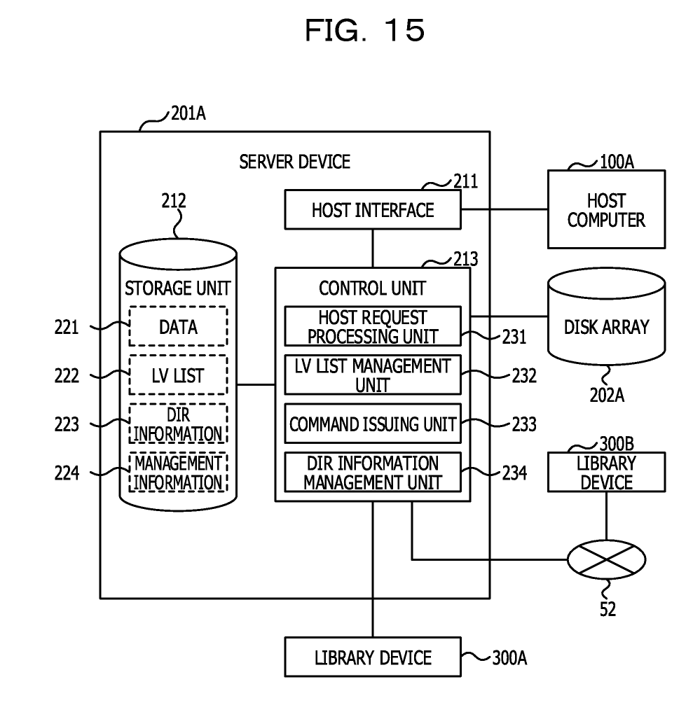

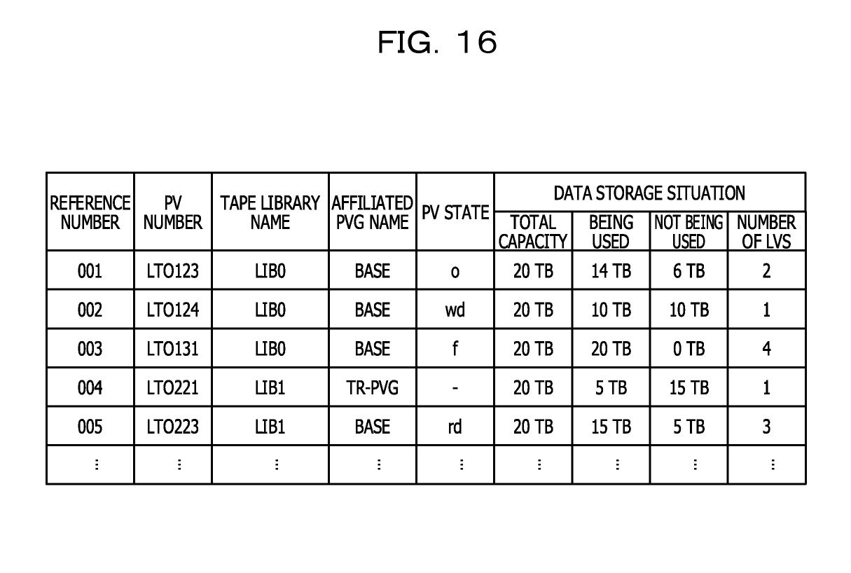

Subsequently, the functions of the virtual tape device 200 will be described with reference to FIGS. 15 and 16. FIG. 15 is a block diagram illustrating an example of functions of a server device according to the second embodiment. FIG. 16 is a diagram illustrating an example of management information managed by a server device according to the second embodiment. Here, the server device 201A included in the virtual tape device 200A is focused on and described.

As depicted in FIG. 15, the server device 201A includes a host interface 211, a storage unit 212, and a control unit 213. The function of the host interface 211 may be realized using the above-described connection port 924, the communication unit 926, or the like. The function of the control unit 213 may be realized using the above-described CPU 902 or the like. The function of the storage unit 212 may be realized using the above-described RAM 906, the storage unit 920, or the like.

The host interface 211 is an interface to transmit or receive information to or from the host computer 100A. For example, the host interface 211 receives a processing request from the host computer 100A. In this case, the host interface 211 inputs the received processing request to the control unit 213. The host interface 211 transmits a notification of a processing result received from the control unit 213 to the host computer 100A. In addition, the host interface 211 is used when data is transmitted to or received from the host computer 100A.

The storage unit 212 stores therein data used by the control unit 213 or the like. For example, the storage unit 212 stores therein the data 221 of the logical volume, which is transmitted to the library device 300B through the remote copying. The storage unit 212 stores therein a list (LV list) 222 of the logical volumes which transmit data to the library device 300B through the remote copying. The storage unit 212 stores therein DIR information 223 transmitted to the library device 300B when the remote copying is performed. The storage unit 212 stores therein management information 224 used to manage the information about the tape cartridge 400.

The management information 224 includes information such as a reference number, a PV number, a tape library name, an affiliated PVG name, a PV state, and a data storage situation as depicted in FIG. 16. The reference number is an index of a database. The PV number is an example of information used to identify the tape cartridge 400. The tape library name is an example of information used to identify the library device 300 which stores the tape cartridge 400.

The affiliated PVG name is an example of information used to identify a PVG to which the tape cartridge 400 belongs. The PVG name includes, for example, “BASE” (a name of a PVG used for backup of one or more logical volumes) or a “TR-PVG” (a name of a PVG used when the import process or the export process is performed). The PV state information is information indicative of the use state of the tape cartridge 400. For example, the PV state information includes information indicative of states of unused (“-”), usable (“o”), being written (“wd”), being read (“rd”), failed (“f”), and the like. The data storage situation information includes information such as the total capacity of the magnetic tape 401, the capacity being used, the capacity not being used, the number of logical volumes, data of which is recorded in the magnetic tape 401, and the like.

The control unit 213 includes a host request processing unit 231, an LV list management unit 232, a command issuing unit 233, and a DIR information management unit 234.

The host request processing unit 231 receives processing requests through the host interface 211. The processing requests includes, for example, a data writing request, a data reading request, a request for the export process, a remote copying request, and the like.

When a data writing request is received, the host request processing unit 231 writes writing target data received from the host computer 100A through the host interface 211 into the disk array 202A. When a data reading request is received, the host request processing unit 231 reads reading target data from the disk array 202A, and transmits the reading target data to the host computer 100A through the host interface 211. In a case of the Cache Miss, the host request processing unit 231 reads the data of the logical volume from the library device 300A and stores the read data in the disk array 202A.

In addition, the host request processing unit 231 appropriately performs the migration process of a logical volume, data of which is stored in the disk array 202A. When a request for the export process is received, the host request processing unit 231 writes data of a logical volume targeted to the export process in a tape cartridge 400 of the library device 300A in the data format depicted in FIG. 12. Then, the host request processing unit 231 discharges the tape cartridge 400 to the outside of the library device 300A.

Control on the disk array 202A and the library devices 300A and 300B is performed by the control unit 213 using a command. For example, a process to write the DIR information in the tape cartridge 400 is performed using a DIR information writing command. The command is issued by the command issuing unit 233. For example, when the DIR information is written in the tape cartridge 400 while the export process is being performed, the host request processing unit 231 requests the command issuing unit 233 to transmit the DIR information writing command to the library device 300A. The DIR information is prepared by the DIR information management unit 234 when the export process or the remote copying is performed.

Here, the function of the control unit 213 will be further described while assuming a case where a remote copying request, which targets two logical volumes LV-A and LV-B, is received.

When the remote copying request is received from the host computer 100A, the host request processing unit 231 stores the data 221 of the logical volume targeted to the remote copying in the storage unit 212. The LV list management unit 232 prepares an LV list 222 of the logical volumes targeted to the remote copying, and stores the prepared LV list 222 in the storage unit 212. The host request processing unit 231 transmits data of a single logical volume LV-A to the library device 300B based on the LV list 222, and causes the data of the logical volume LV-A to be written in a tape cartridge 400 of the library device 300B.

When a notification of the completion of the writing is received from the library device 300B, the DIR information management unit 234 prepares DIR information with regard to the logical volume LV-A, and stores the prepared DIR information in the storage unit 212. The host request processing unit 231 transmits the DIR information prepared by the DIR information management unit 234 to the library device 300B.

The command issuing unit 233 issues a DIR information writing command, and transmits the issued DIR information writing command to the library device 300B. At this time, the command issuing unit 233 issues a DIR information writing command (hereinafter, referred to as a temporal DIR information writing command) that is different from a DIR information writing command used to write the DIR information in the magnetic tape 401, and transmits the issued temporal DIR information writing command to the library device 300B. The temporal DIR information writing command is a command to instruct the controller 301B of the library device 300B to write the DIR information in the memory of the controller 301B and the cartridge memory 402 of the tape cartridge 400.

The host request processing unit 231 transmits data of a single logical volume LV-B to the library device 300B based on the LV list 222, and causes the data of the logical volume LV-B to be written in the tape cartridge 400 of the library device 300B. When a notification of the completion of writing is received from the library device 300B, the DIR information management unit 234 prepares the DIR information with regard to the logical volumes LV-A and LV-B, and stores the prepared DIR information in the storage unit 212. The host request processing unit 231 transmits the DIR information prepared by the DIR information management unit 234 to the library device 300B.

The command issuing unit 233 issues a DIR information writing command, and transmits the issued DIR information writing command to the library device 300B. The DIR information writing command issued at this time is a command to write the DIR information in the magnetic tape 401. The host request processing unit 231 updates the management information 224 stored in the storage unit 212 such that a state acquired after the remote copying is performed is reflected. The host request processing unit 231 transmits a notification that the remote copying is completed to the host computer 100A through the host interface 211.

Hereinabove, the functions of the virtual tape device 200 have been described. As above, the DIR information is prepared and transmitted to the library device 300B in each transmission of data of a single logical volume. Therefore, even when the transmission of data of a logical volume fails, it is possible to activate a logical volume which has already been written, by using the DIR information that is present at the time.

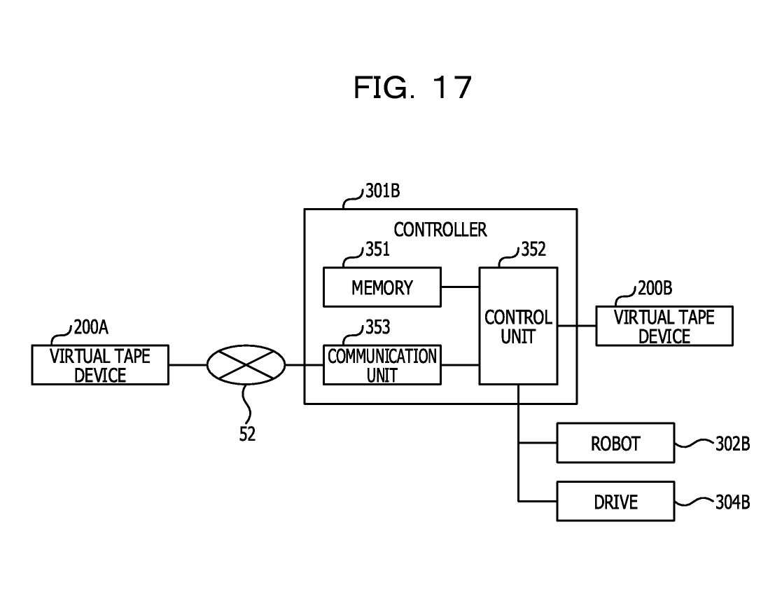

Subsequently, functions of the library device 300 will be described with reference to FIG. 17. FIG. 17 is a diagram illustrating an example of functions of a controller according to the second embodiment. Here, the controller 301B included in the library device 300B is focused on and described.

As depicted in FIG. 17, the controller 301B includes a memory 351, a control unit 352, and a communication unit 353. The control unit 352 may be a processor, such as a CPU or a DSP, or may be an electronic circuit, such as an ASIC or an FPGA, other than the processor. The control unit 352 executes, for example, a program stored in the memory 351.

The control unit 352 controls the operations of the robot 302B and the drive 304B. For example, the control unit 352 controls the robot 302B such that a tape cartridge 400 moves between the cell 303B, the drive 304B, and the cartridge input/output mechanism 321. In addition, the control unit 352 performs a process to write data in a tape cartridge 400 mounted on the drive 304B or a process to read data from the tape cartridge 400.

The control unit 352 writes data of a logical volume, which is received from the virtual tape device 200A through the communication unit 353 in the case of the remote copying, into a tape cartridge 400. When the writing process performed on the tape cartridge 400 is completed, the control unit 352 transmits a notification that the writing process is completed to the virtual tape device 200A through the communication unit 353.

The control unit 352 interprets a temporal DIR information writing command received from the virtual tape device 200A, and stores the DIR information received from the virtual tape device 200A in the memory 351. The control unit 352 also writes the DIR information in the cartridge memory 402 of the tape cartridge 400. When a DIR information writing command indicative of an instruction to write the DIR information in a magnetic tape 401 is received, the control unit 352 writes the DIR information in the magnetic tape 401 of the tape cartridge 400.

Hereinabove, the functions of the library device 300 have been described.

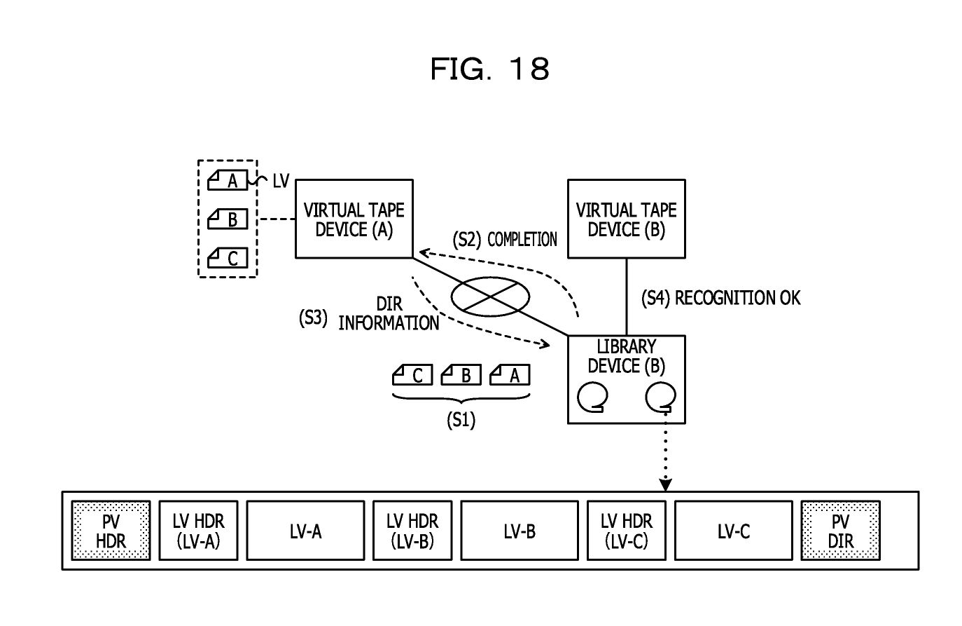

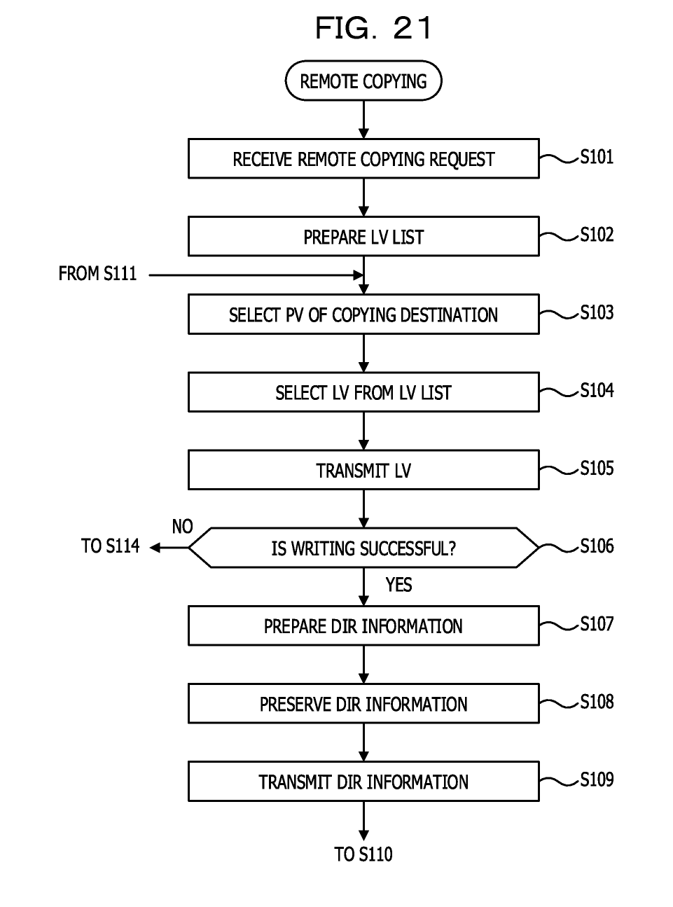

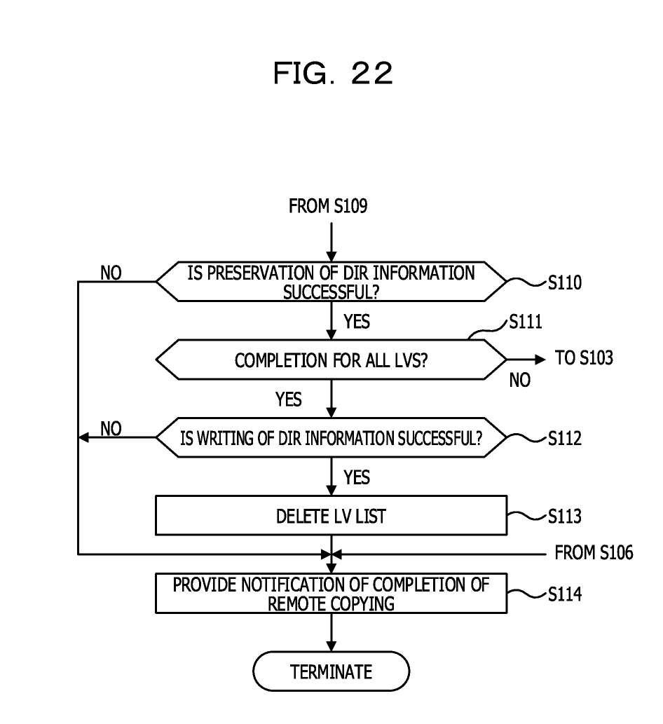

Subsequently, a processing flow of the remote copying will be described with reference to FIGS. 18 to 22. First, an advantage acquired when the DIR information is transmitted in each transmission of data of a single logical volume will be described with reference to FIGS. 18 to 20, and, subsequently, the processing flow will be described with reference to FIGS. 21 and 22.

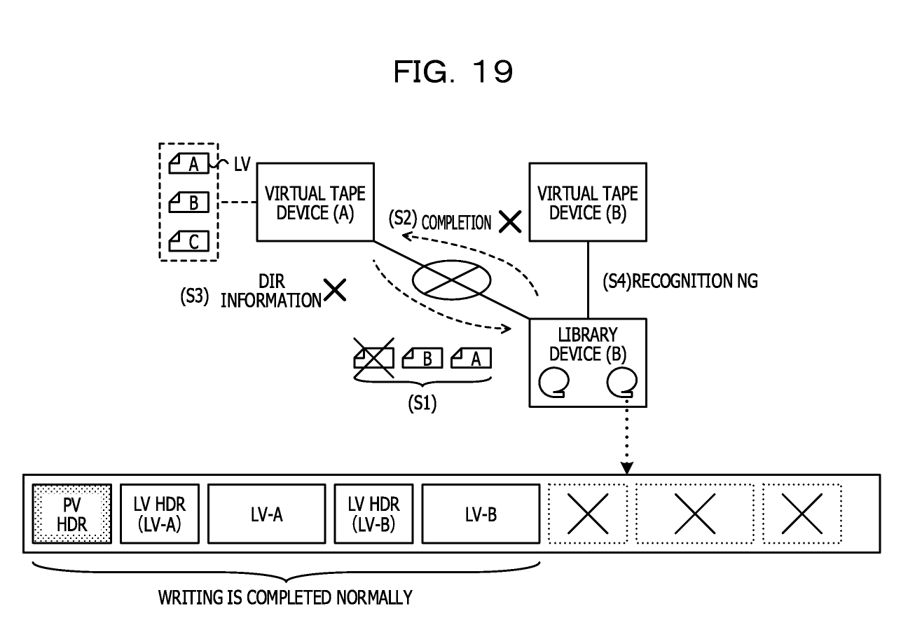

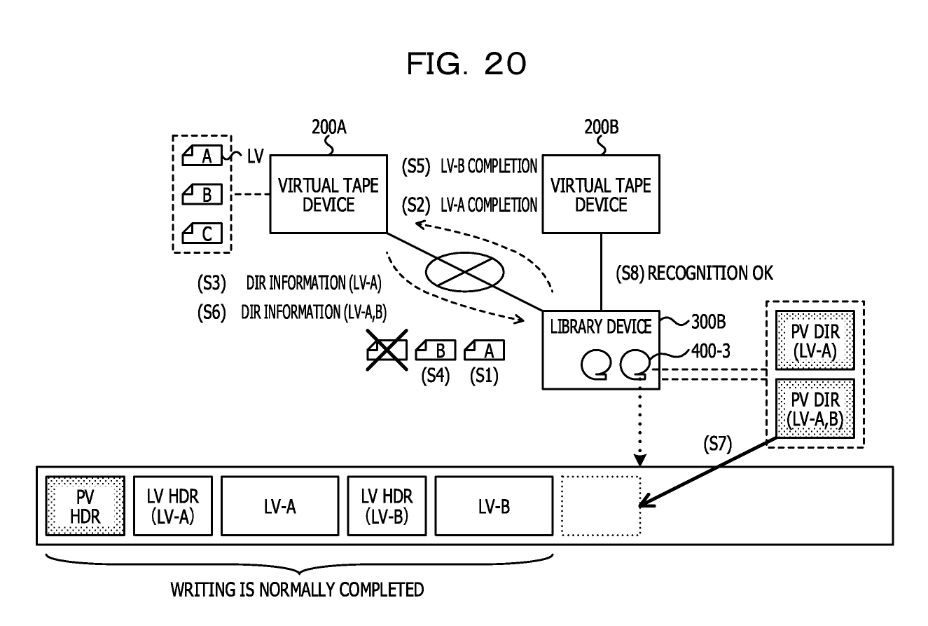

FIG. 18 is a first diagram illustrating a remote copying process when the DIR information is prepared after data of entire writing target logical volumes is written in a magnetic tape. FIG. 19 is a second diagram illustrating a remote copying process when the DIR information is prepared after data of entire writing target logical volumes is written in a magnetic tape. FIG. 20 is a diagram illustrating a remote copying process when a method of preparing the DIR information according to the second embodiment is applied.

As in a comparison example depicted in FIG. 18, a case is assumed in which the DIR information is prepared after data of entire logical volumes LV-A, . . . , and LV-C targeted to the remote copying has been written. In this example, the data of the logical volumes LV-A, . . . , and LV-C is sequentially transmitted from a virtual tape device (A) (S1) and written in a magnetic tape by a library device (B). When a notification of completion is received from the library device (B) (S2) and when it is checked that the data of entire logical volumes LV-A, . . . , and LV-C is written, the virtual tape device (A) transmits DIR information to the library device (B) (S3). When the DIR information is written in the magnetic tape by the library device (B), the virtual tape device (B) may recognize the data of the logical volumes, which is written in the magnetic tape (S4).

However, as in a comparison example depicted in FIG. 19, if the data of the logical volume LV-C does not reach (denoted by a cross in FIG. 19) the library device (B) for some reason, the notification of completion is not transmitted (denoted by a cross in FIG. 19) from the library device (B). Therefore, the DIR information is not transmitted (denoted by a cross in FIG. 19) from the virtual tape device (A) to the library device (B). In this case, the data of the logical volume LV-C and the DIR information are not written in the magnetic tape. Accordingly, even though the data of the logical volumes LV-A and LV-B is written in the magnetic tape, it is not possible for the virtual tape device (B) to recognize the data of the logical volumes LV-A and LV-B due to the absence of the DIR information.

On the other hand, even though there a plurality of logical volumes targeted to the remote copying, the virtual tape device 200A according to the second embodiment prepares DIR information and transmits the prepared DIR information to the library device 300B whenever the writing of data of each logical volume is completed. Therefore, as depicted in FIG. 20, even when the data of the logical volume LV-C does not reach (denoted by a cross in FIG. 20) the library device 300B for some reason, the library device 300B maintains the DIR information with regard to the logical volumes LV-A and LV-B, the writing of data of which has already been completed. Accordingly, when the library device 300B writes the maintained latest DIR information in the magnetic tape 401, the virtual tape device 200B may recognize the logical volumes LV-A and LV-B, the writing of data of which has been completed.

When network failure is generated during the remote copying and thus the transmission of the logical volumes stops as above, for example, retransmission of data or the like is performed. In the cases of the comparison examples depicted in FIGS. 18 and 19, retransmission of data of the logical volumes LV-A, . . . , and LV-C is performed. On the other hand, in the case of the example depicted in FIG. 20, if only the data of the logical volume LV-C is retransmitted, it is assumed that the transmission of the data of the logical volumes LV-A, . . . , and LV-C is finished. Therefore, the efficiency of the remote copying is implemented. In addition, even until failures are repaired, the virtual tape device 200B may use the data that is already written, thereby reducing influence on and risk to transactions performed by the host computer 100B.

Subsequently, a process performed by the virtual tape device 200A on a side that transmits data of a logical volume will be described with reference to FIGS. 21 and 22. FIG. 21 is a first flowchart illustrating a flow of a process performed by a virtual tape device on a side that transmits data of a logical volume according to the second embodiment when the remote copying is performed. FIG. 22 is a second flowchart illustrating a flow of a process performed by a virtual tape device on a side that transmits data of a logical volume according to the second embodiment when the remote copying is performed. The processes depicted in FIGS. 21 and 22 are mainly performed by the server device 201A.

The host interface 211 receives a remote copying request from the host computer 100A (S101). The host interface 211 inputs, to the control unit 213, information indicating that the remote copying request is received and information indicating a logical volume targeted to the remote copying.

The LV list management unit 232 prepares an LV list 222 based on the information input from the host interface 211 (S102). The LV list 222 is acquired by listing information about the logical volumes, data of which is transmitted to the library device 300B, in order of transmission. The LV list management unit 232 stores the prepared LV list 222 in the storage unit 212.

The host request processing unit 231 refers to the management information 224 stored in the storage unit 212, and selects a tape cartridge 400 in which the data of the logical volumes is to be written (S103). For example, the host request processing unit 231 selects a tape cartridge 400 such that an LVG, to which a writing target logical volume belongs, corresponds to a PVG to which the tape cartridge 400 belongs and the PV state of the tape cartridge 400 is usable (o).

The host request processing unit 231 selects a logical volume, which is not yet transmitted, based on the LV list 222 stored in the storage unit 212 (S104). The host request processing unit 231 reads data of the selected logical volume from the disk array 202A, and stores the read data in the storage unit 212.

The host request processing unit 231 transmits the data of the logical volume selected in S104 to the library device 300B (S105), and causes the data to be written in the tape cartridge 400 selected in S103. When the writing is completed, the host request processing unit 231 receives a notification of completion of the writing from the library device 300B.

When the host request processing unit 231 receives the notification of completion of the writing (YES in S106), the process proceeds to S107. When the host request processing unit 231 does not receive the notification of completion of the writing (NO in S106), the process proceeds to S114 in FIG. 22.

The DIR information management unit 234 prepares DIR information corresponding to a state in which the data of the logical volume, which is transmitted by the host request processing unit 231 in S105, is written in the tape cartridge 400 (S107). The DIR information management unit 234 preserves the prepared DIR information in the storage unit 212 (S108).

The DIR information management unit 234 transmits the DIR information prepared in S107 to the library device 300B (S109). Further, the command issuing unit 233 transmits a temporal DIR information writing command to the library device 300B. The DIR information is preserved in the memory 351 included in the controller 301B of the library device 300B and in the cartridge memory 402 of the tape cartridge 400 in accordance with the temporal DIR information writing command. When the process in S109 is completed, the process proceeds to S110 in FIG. 22.

When the preservation of the DIR information is successful in S109 (YES in S110), the process proceeds to S111. When the preservation of the DIR information fails in S109 (NO in S110), the process proceeds to S114. For example, if a network failure is generated during the transmission of the DIR information and the DIR information or the temporal DIR information writing command does not reach the library device 300B, the preservation of the DIR information fails. When the preservation of the DIR information is successful, a notification of the completion of the preservation is transmitted from the library device 300B to the virtual tape device 200A.

When the data of entire logical volumes listed in the LV list 222 has been completely written in the tape cartridge 400 of the library device 300B (YES in S111), the process proceeds to S112. When data of some logical volumes listed in the LV list 222 is not yet written (NO in S111), the process returns to S103 in FIG. 21.

The command issuing unit 233 transmits a DIR information writing command to the library device 300B (S112), and causes the latest DIR information to be written in the magnetic tape 401 of the tape cartridge 400. When the writing of the DIR information is successful, the process proceeds to S113. When the writing of the DIR information fails, the process proceeds to S114.

The LV list management unit 232 deletes the LV list 222 stored in the storage unit 212 (S113).

The host request processing unit 231 notifies the host computer 100A of the completion of the remote copying through the host interface 211 (S114). When the process in S114 is finished, a series of processes depicted in FIGS. 21 and 22 is terminated.

Hereinabove, the processing flow of the remote copying has been described.

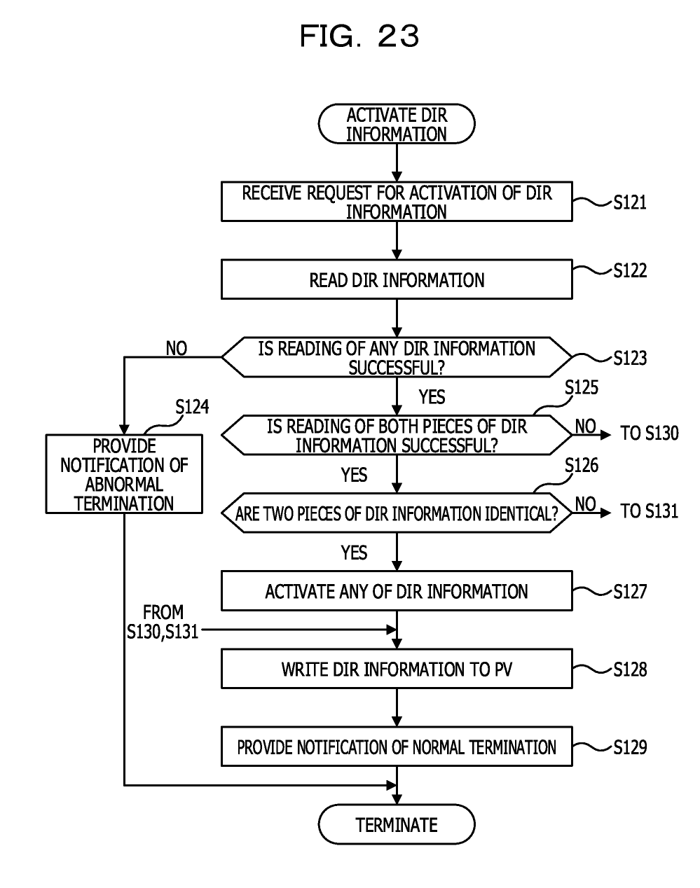

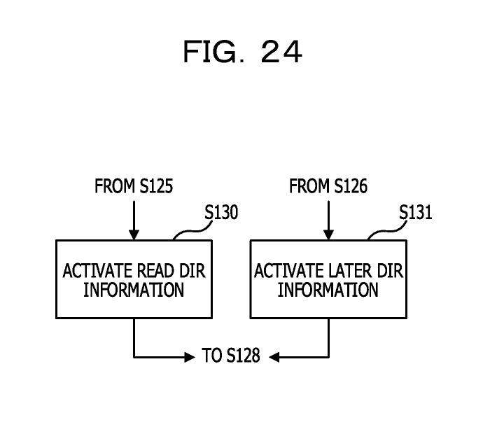

Subsequently, a flow of a process to activate data of a logical volume, which is written in the tape cartridge 400, will be described with reference to FIGS. 23 and 24. The process to activate data of a logical volume is mainly a process to write the DIR information in the magnetic tape 401, and thus the process may be referred to as activation of the DIR information in the description below.

In the above-described examples in FIGS. 21 and 22, the DIR information is written in the magnetic tape 401 when the data of the entire logical volumes listed in the LV list 222 is written in the tape cartridge 400. Therefore, when data is not written in the tape cartridge 400 for some logical volumes, the DIR information is still preserved in the memory 351 of the controller 301B and the cartridge memory 402 of the tape cartridge 400. Here, a process (activation) of the server device 201B to write the DIR information, which is preserved in the memory 351 of the controller 301B or the cartridge memory 402 of the tape cartridge 400, into the magnetic tape 401 will be described.

FIG. 23 is a first flowchart illustrating a flow of a DIR information activation process performed by a virtual tape device on a side that receives data of a logical volume according to the second embodiment. FIG. 24 is a second flowchart illustrating a flow of a DIR information activation process performed by a virtual tape device on a side that receives data of a logical volume according to the second embodiment. The process related to the activation is mainly performed by the server device 201B on a side that receives the data of the logical volume.

The server device 201B receives a request (activation request) for activation of the DIR information from the host computer 100B (S121). For example, when data of some logical volumes is not written in the tape cartridge 400 due to a network failure and the network failure is not repaired for a long time (first predetermined time), the activation request is transmitted from the host computer 100B. The server device 201B receives the activation request.

The server device 201B reads the DIR information preserved in the memory 351 of the controller 301B and the cartridge memory 402 of the tape cartridge 400 (S122). When the DIR information is read from at least one of the memory 351 of the controller 301B and the cartridge memory 402 of the tape cartridge 400 (YES in S123), the process proceeds to S125. When the DIR information is read from neither the memory 351 of the controller 301B nor the cartridge memory 402 of the tape cartridge 400 (NO in S123), the process proceeds to S124.

The server device 201B provides a notification of abnormal termination (activation failure) and completion of the activation process to the host computer 100B (S124). When the process in S124 is completed, a series of processes depicted in FIGS. 23 and 24 is terminated.

When the DIR information is read from both the memory 351 of the controller 301B and the cartridge memory 402 of the tape cartridge 400 (YES in S125), the process proceeds to S126. When the DIR information is read from only one of the memory 351 of the controller 301B and the cartridge memory 402 of the tape cartridge 400 (NO in S125), the process proceeds to S130 in FIG. 24.

The server device 201B compares two pieces of DIR information read from the memory 351 of the controller 301B and the cartridge memory 402 of the tape cartridge 400 (S126). When the two pieces of DIR information are identical to each other (YES in S126), the process proceeds to S127. When the two pieces of DIR information are not identical to each other (NO in S126), the process proceeds to S131 in FIG. 24.

The server device 201B activates any one of the two pieces of DIR information read from the memory 351 of the controller 301B and the cartridge memory 402 of the tape cartridge 400 (S127). That is, the server device 201B sets (activates) the DIR information to be written in the magnetic tape 401.

The server device 201B writes the activated DIR information in the magnetic tape 401 of the tape cartridge 400 (S128).

The server device 201B notifies the host computer 100B of normal termination (success of activation) and completion of the activation process (S129). When the process in S129 is completed, a series of processes depicted in FIGS. 23 and 24 is terminated.

The server device 201B activates the DIR information that is successfully read (S130). That is, the server device 201B sets (activates) the DIR information to be written in the magnetic tape 401. When the process in S130 is completed, the process proceeds to S128.

The server device 201B activates DIR information, which has a later update time, of the read two pieces of DIR information (S131). That is, the server device 201B sets (activates) DIR information to be written in the magnetic tape 401. When the process in S131 is completed, the process proceeds to S128.

Hereinabove, the flow of the process to activate the data of the logical volume, which is written in the tape cartridge 400, has been described.

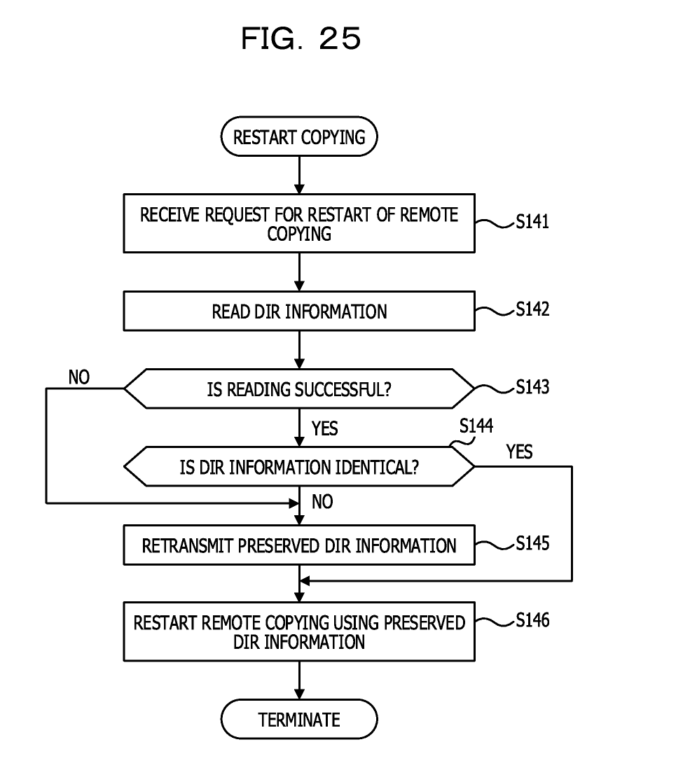

The example in FIGS. 23 and 24 correspond to a process assuming that the activation request is transmitted from the host computer 100B while the network failure is not repaired for a long time. On the other hand, there is a case where the network failure is repaired in a short time and the data of the logical volume may be transmitted again before the activation request is transmitted from the host computer 100B. Here, a flow of a process which is performed when the remote copying is restarted will be described with reference to FIG. 25.

FIG. 25 is a flowchart illustrating a flow of a process which is performed when an interrupted remote copying is restarted by a virtual tape device on a side that transmits data of a logical volume according to the second embodiment. The process illustrated in FIG. 25 is performed by the server device 201A that is the side that transmits the data of the logical volume.

The host request processing unit 231 receives a request for restart of remote copying from the host computer 100A through the host interface 211 (S141). As a modified example, a system that automatically detects the restoration from the network failure and the host request processing unit 231 thereof restarts the remote copying may be used. In this case, S141 is omitted.

The DIR information management unit 234 reads the DIR information from the library device 300B (S142). In this case, the DIR information management unit 234 acquires the DIR information, which is read from the memory 351 of the controller 301B or the cartridge memory 402 of the tape cartridge 400, from the library device 300B. When reading of the DIR information is successful (YES in S143), the process proceeds to S144. When the reading of the DIR information fails (NO in S143), the process proceeds to S145.

The DIR information management unit 234 compares the DIR information preserved in the storage unit 212 with the DIR information read from the library device 300B (S144). When the two pieces of DIR information are identical to each other (YES in S144), the process proceeds to S146. When the two pieces of DIR information are not identical to each other (NO in S144), the process proceeds to S145.

The DIR information management unit 234 the DIR information preserved in the storage unit 212 to the library device 300B (S145).

The host request processing unit 231 restarts the remote copying using the DIR information preserved in the storage unit 212 (S146). For example, when the logical volumes LV-A, LV-B, and LV-C are written in the LV list 222 and DIR information related to the logical volumes LV-A and LV-B are preserved in the storage unit 212, the host request processing unit 231 determines that the process to write the logical volumes LV-A and LV-B is completed. Then, the host request processing unit 231 restarts the remote copying process from the data of the logical volume LV-C. When the process in S146 is completed, a series of processes depicted in FIG. 25 is terminated.

Hereinabove, the second embodiment has been described.

According to the second embodiment, even when a failure is not repaired for a while, it is possible to use the DIR information preserved in the library device on the side that receives the data of the logical volume and to activate the logical volumes which have been completely written in the magnetic tape. A process related to the activation is performed by the virtual tape device or the library device of the center in which the library device is installed. Therefore, even in a situation in which network failure or the like is continuously generated, it is possible to perform the process related to the activation without receiving the influence thereof. In addition, when the failure is repaired in a short time, it is possible to restart the remote copying process from the logical volume which has not been completely written in the magnetic tape.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A data management device comprising:
a processor configured to
transmit data of a logical volume to a library device different from the data management device so as to record the data of the logical volume on a portable recording medium managed by the library device;
prepare recognition information whenever data of a logical volume is recorded on the portable recording medium, the recognition information being used to recognize entire first logical volumes, data of the first logical volumes being recorded on the portable recording medium; and
transmit the recognition information to the library device so as to record the recognition information on the portable recording medium.

2. A data management system comprising:
a library device; and
a first data management device different from the library device, the first data management device including:
a first processor configured to
transmit data of a logical volume to the library device so as to record the data of the logical volume on a portable recording medium managed by the library device,
prepare recognition information whenever data of a logical volume is recorded on the portable recording medium, the recognition information being used to recognize entire first logical volumes, data of the first logical volumes being recorded on the portable recording medium, and
transmit the recognition information to the library device so as to record the recognition information on the portable recording medium.

3. The data management system according to claim 2, wherein
the first data management device is installed in a first center, and
the library device is installed in a second center different from the first center,
the data management system further comprising:
a second data management device installed in the second center and connected to the library device, the second data management device including:
a second processor configured to
recognize, based on the recognition information recorded on the portable recording medium, the first logical volumes when using the data of the first logical volumes.

4. The data management system according to claim 3, wherein
the library device includes a third processor configured to
receive the recognition information transmitted from the first data management device,
preserve the received recognition information in a storage device included in a cartridge of the portable recording medium, the storage device being different from the portable recording medium, and
record the preserved recognition information on the portable recording medium.

5. The data management system according to claim 4, wherein
the library device includes a memory, and
the third processor is configured to
preserve the received recognition information in the memory,
compare first recognition information preserved in the storage device with second recognition information preserved in the memory, and
record, when the first recognition information is identical to the second recognition information, either one of the first recognition information and the second recognition information on the portable recording medium.

6. The data management system according to claim 5, wherein
the third processor is configured to
select, when the first recognition information is not identical to the second recognition information, recognition information having later recording date and time between the first recognition information and the second recognition information, and
record the selected recognition information on the portable recording medium.

7. A data management method comprising:
transmitting, by a data management device, data of a logical volume to a library device different from the data management device so as to record the data of the logical volume on a portable recording medium managed by the library device;
preparing recognition information whenever data of a logical volume is recorded on the portable recording medium, the recognition information being used to recognize entire first logical volumes, data of the first logical volumes being recorded on the portable recording medium; and
transmitting the recognition information to the library device so as to record the recognition information on the portable recording medium.
